(19) United States
(12) Patent Application Publication
(10) Pub. No.: US 2025/0113787 A1
(43) Pub. Date: Apr. 10, 2025

(54) CONTROL SYSTEM FOR AN IRRIGATION SYSTEM VALVE USING WIRELESS COMMUNICATION

(71) Applicant: K-Rain Manufacturing Corp., Riviera Beach, FL (US)

(72) Inventor: Trevor P. Kah, North Palm Beach, FL (US)

(21) Appl. No.: 18/907,105

(22) Filed: Oct. 4, 2024

Related U.S. Application Data
(60) Provisional application No. 63/542,353, filed on Oct. 4, 2023.

(51) Int. Cl. A01G 25/16; G05D 7/06

(52) U.S. Cl. CPC A01G 25/165; G05D 7/0652

(57) ABSTRACT

A control system for an irrigation system including wireless communication controlled based on flow of water in the irrigation system. The control system is operably connected to one or more valves of an irrigation system and controls the flow of water therethrough in accordance with a watering program or other instructions. The control system is operably connected to flow sensors that detect flow of water through the one or more of the valves in the irrigation system. Wireless communication is turned on and off based on detected flow through the valves to save power. In embodiments, the flow sensors may be turbine sensors and may generate electricity based on the detected flow of water to recharge a power source in the control system.

### CROSS-REFERENCE TO RELATED APPLICATIONS

The present application claims benefit of and priority to U.S. Provisional Patent Application Ser. No. 63/542,353 filed Oct. 4, 2023 entitled A CONTROL SYSTEM FOR AN IRRIGATION SYSTEM VALVE USING WIRELESS COMMUNICATION, the content of which is hereby incorporated by reference herein.

### BACKGROUND

### Field

The present application relates to a control system for controlling at least one valve in an irrigation system, wherein the control system includes wireless communication.

### Related Art

Irrigation systems may include multiple irrigation zones and/or stations which may be individually controlled. In embodiments, each irrigation zone may include a valve, or valves that may control water flow to one or more irrigation stations in the zone. In embodiments, each valve may be individually controlled to provide water to the irrigation stations in accordance with a watering program, for example. In embodiments, each valve may be controlled by a control system operably connected thereto which provides control signals to open or close the valve. In embodiments, the control system may include a power source, such as a battery, which may be used to provide power to a solenoid or other switching element at the valve to open and close the valve.

One drawback of such irrigation systems is that the power source or battery is typically in use for a relatively long period of time and is inconvenient to replace. Where the control system includes wireless communication abilities, the battery or other power source discharges at a rapid rate.

Accordingly, it would be useful to provide a control system for controlling a valve in an irrigation system that avoids these and other problems.

### SUMMARY

A control system in an irrigation system that includes wireless communication includes one or more flow sensors to detect flow of water through one or more the valves in the irrigation system wherein the wireless transceiver is turned on and off based on water flow to conserve power. In embodiments, the flow sensor may be used to generate electricity to recharge a power source at the control system.

A control system in accordance with an embodiment of the present disclosure includes a control unit: a first valve operably connected to the control unit and in fluid communication with a first irrigation line to control flow through the first irrigation line; a first flow sensor provided in fluid communication with the first irrigation line, the first flow sensor operable to provide flow information associated with flow if water through the first irrigation line; a first radio operably connected to the control unit and switchable from an active state in which the radio sends and receives information and a latent state in which it does not transmit or receive; and a power source electrically connected to the control unit and first radio and to provide power thereto, wherein the control unit activates the first radio after receiving flow information indicating flow of water in the first irrigation line.

In embodiments, the control unit includes: a processor; and memory operably connected to the processor including processor executable code that when executed by the processor performs steps of: receiving the flow information; generating a first activation signal to activate the first radio when the flow information is received indicating flow of water in the first irrigation line; and providing the first activation signal to the first radio to activate the first radio.

In embodiments, the first activation signal activates the first radio for a predetermine period of time.

In embodiments, the memory includes processor executable instructions that when executed by the processor perform steps of: generating a deactivation signal a predetermined period of time after the activation signal is generated; sending the deactivation signal to the first radio.

In embodiments, the memory includes processor executable instructions that when executed by the processor perform steps of: generating a deactivation signal after the flow information indicates that water is not flowing through the first irrigation line; sending the deactivation signal to the first radio.

In embodiments, the first radio is configured to send and receive information using at least one of LTE, Cat-M, LTE-M, Cat NB-IoT, LTE Cat1, LoRaWAN, and Zigbee communication.

In embodiments, the first radio operates at a sub-Gigahertz frequency.

In embodiments, the system includes: a second valve operably connected to the control unit and in fluid communication with a second irrigation line to control flow through the second irrigation line; and a second flow sensor provided in fluid communication with the second irrigation line, the second flow sensor operable to provide second flow information associated with flow of water through the second irrigation line, wherein the control unit activates the first radio after receiving second flow information indicating flow of water in the second irrigation line.

In embodiments, the control unit activates the first radio after receiving the first flow information or the second flow information.

In embodiments, the system includes a second radio operably connected to the control unit, wherein the control unit activates the second radio after receiving the first flow information indicating flow of water in the first irrigation line.

In embodiments, the second radio provides short range wireless communication.

In embodiments, the first flow sensor is a turbine flow sensor and configured to provide power to the power source when water is flowing through the first irrigation line.

In embodiments, the second flow sensor is a turbine flow sensor configured to provide power to the power source when water is flowing through the second irrigation line.

In embodiments, the memory includes processor executable instructions that when processed by the control system perform steps of: processing the first flow information and determining whether water is leaking from the first irrigation line.

In embodiments, the step of processing the first flow information includes comparing the first flow information to a state of the first valve, wherein when the first flow information indicates water flow in the first irrigation line when the first valve is closed, a leak is indicated.

In embodiments, the memory includes processor executable instructions that when processed by the control system perform steps of: processing the second flow information and determining whether water is leaking from the second irrigation line.

In embodiments, the step of processing the second flow information includes comparing the second flow information to a state of the second valve, wherein when the second flow information indicates water flow in the second irrigation line when the second valve is closed, a leak is indicated.

In embodiments, the processor executable instructions include watering program instructions that when executed by the processor perform steps of: generating a first valve activation signal to activate the first valve to supply water to the first irrigation line.

In embodiments, the processor executable instructions include watering program instructions that when executed by the processor perform steps of: generating a second valve activation signal to activate the second valve to supply water to the second irrigation line.

In embodiments, the memory includes processor executable code that, when executed by the processor, performs steps of: calculating a flow rate based on the flow information; generating a flow rate message when the flow rate exceeds a first threshold or falls below a second threshold; and transmitting the flow rate message using the first radio.

In embodiments, the memory includes processor executable code that when executed by the processor performs steps of: generating a flow signal indicating that flow has been detected based on the flow information; and transmitting the flow signal using the first radio after the first radio is activated.

In embodiments, a control system in accordance with an embodiment of the present disclosure includes: a control unit including: a processor; and memory operably connected to the processor including processor executable code including a watering program that when executed by the processor provides control signals; a first valve operably connected to the control unit and in fluid communication with a first irrigation line to control flow through the first irrigation line based on the control signals; a first radio operably connected to the control unit and switchable from an active state in which the radio sends and receives information and a latent state in which it does not transmit or receive; a power source electrically connected to the control unit and first radio and to provide power thereto, wherein the control unit activates the first radio in accordance with the watering program.

In embodiments, a control system in accordance with an embodiment of the present disclosure includes: a control unit including: a processor; and memory operably connected to the processor including processor executable code including a watering program that when executed by the processor provides control signals; a first valve operably connected to the control unit and in fluid communication with a first irrigation line to control flow through the first irrigation line based on the control signals; a first radio operably connected to the control unit and switchable from an active state in which the radio sends and receives information and a latent state in which it does not transmit or receive; a power source electrically connected to the control unit and first radio and to provide power thereto, wherein the processor executable code, when executed by the processor, performs steps of: establishing a flow time based on the flow information; comparing the flow time to the watering program to determine whether the flow time corresponds to an on time for the first valve in accordance with the watering program; generating an alert message when the flow time does not correspond to an on time for the first valve in accordance with the watering program; and transmitting the alert message using the first radio.

A control system in accordance with an embodiment of the present disclosure includes a control unit including: a processor; and memory operably connected to the processor including processor executable code including a watering program that when executed by the processor provides control signals; a first valve operably connected to the control unit and in fluid communication with a first irrigation line to control flow through the first irrigation line based on the control signals; a first radio operably connected to the control unit and switchable from an active state in which the radio sends and receives information and a latent state in which it does not transmit or receive; a power source electrically connected to the control unit and first radio and to provide power thereto, wherein the processor executable code, when executed by the processor, performs steps of: determining an on time for the first valve based on the watering program; determining whether water is flowing in the first irrigation line during the on time; generating an alert message when the flow information indicates that water is not flowing in the first irrigation line during the on time; and transmitting the alert message using the first radio.

### BRIEF DESCRIPTION OF THE DRAWINGS

FIG. 1 shows an exemplary block diagram of a control system for use in controlling an irrigation system in accordance with an embodiment of the present invention.

### DESCRIPTION OF THE EMBODIMENTS

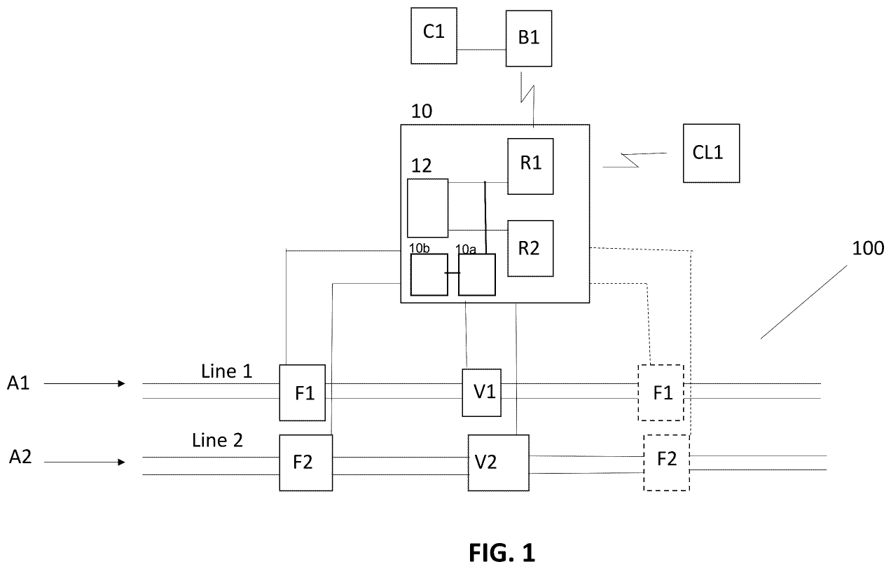

An irrigation control system 100 in accordance with an embodiment of the present invention is shown in FIG. 1. In embodiments, a control unit 10 provides control signals to one or more valves V1, V2 to control flow of water through irrigation lines. The irrigation control system 100 shows two lines L1, L2 through which water flows, but additional or fewer lines may be used. In embodiments, a first valve V1 controls flow of water through line L1 and a second valve V2 controls flow of water through line L2. In embodiments, valve V1 opens to allow water to flow through line L1, in the direction illustrated by arrow A1 and closes to prevent flow of water. In embodiments, additional or fewer valves may be used in the system 100. In embodiments, one or more irrigation stations may be provided in fluid communication with the lines L1, L2 downstream from the valve V1, V2 such that water flows through the valve V1, V2 in line L1, L2 and to the various irrigation stations. In embodiments, the valve V2 opens to allow water to flow through line L2, in the direction illustrated by arrow A2 and closes to prevent flow of water. In embodiments, one or more additional irrigation stations may be provided in fluid communication with the lines L1, L2 downstream of the valves V1, V2 such that water flows through the valves V1, V2 in lines L1, L2 and to the various additional irrigation stations.

In embodiments, the control unit 10 may include a first radio R1 configured for wireless communication via a cellular network or other long range communication system. In embodiments, the radio R1 may be used for LTE, Cat-M, LTE-M, Cat NB-IoT, LTE Cat1, LoRaWAN, or Zigbee communication, to name a few. In embodiments, the radio R1 may utilize 900 MHz, or another sub-Gigahertz frequency. In embodiments, the radio R1 may be or may include a transceiver for transmitting and receiving data, for example to receive a watering program, watering instructions or other control information at the control unit 10. In embodiments, the control unit 10 may include a second radio R2 configured for short range wireless communication, such as BLE/Bluetooth communication, for example. In embodiments, the radio R2 may provide Wi-Fi communication. In embodiments, the radio R2 may communicate via any standard radio frequency. In embodiments, the second radio R2 may be, or may include, a transceiver for transmitting and receiving data, which may include a watering program, watering instructions or other control information. In embodiments, the control unit 10 may include a battery 12, or other power source. In embodiments, the power source 12 may be a rechargeable battery or any other suitable power source. In embodiments, the power source 12 may provide power to the first radio R1 and the second radio R2 as well as power to control the valves V1 and V2 and to the control unit 10. In embodiments, the control unit 10 may include memory 10b operably connected to a processor 10a. In embodiments, the memory 10b may include processor executable code that when executed by the processor 10a may generate and transmit control signals to the valves V1 and V2 to open and close the valves. In embodiments, the control signals may be based on a watering program stored in the memory. In embodiments, the watering program may be provided via one or more of the first radio R1 and the second radio R2. In embodiments, the watering program may be updated via one of the first radio R1 and the second radio R2. In embodiments, the control signals may be generated based on instructions that may be provided directly by a user outside of the watering program and provided via the radio R1 and R2.

In embodiments, the first radio R1 may wirelessly communicate with a base station B1 that is part of a cellular communication network. In embodiments, the cellular communication network may provide communication to a remote computer system C1, for example that may be used to provide the watering program or update the watering program. In embodiments, the radio R1 may provide wireless communication via any other communication network including but not limited to the LoRa Network, Zigbee Network, Wi-Fi network and/or an LTE or cellular network, and may provide communication with one or more computer servers or to the Internet. In embodiments, the radio R1 may provide for wireless communication to the cloud CL1 and the watering program may be provided or updated via the cloud.

In embodiments, the radio R2 may be used to provide short range wireless communication, such as via Blue Tooth or any other suitable short range communication protocol including Wi-Fi, as noted above. In embodiments, wireless communication via the second radio R2 may be used to monitor a state of the control unit 10 and may be used to provide or update the watering program.

In embodiments, the control unit 10 may be operably connected to a flow sensor F1 which may be positioned upstream of the valve V1. In embodiments, the flow sensor F1 detects flow of water to and through the valve V1 in the line L1. In embodiments, the control unit 10 activates the first radio R1 for a period of time after flow is detected via the valve V1. In embodiments, the first radio R1 may be active for the period of time that flow is detected. In embodiments, the radio R1 may be active for a period of time after flow starts and/or after flow stops. In embodiments, the radio R1 enters a latent state after it is activated based on the flow detected by and through the valve V1. During the latent state, minimal or no power is provided to the radio R1 such that power is conserved in the control unit 10.

In embodiments, during normal operation, the radio R1 consumes substantial power as it is active on a substantially continuous basis. In embodiments, the control unit 10 may be used at a remote location to control one or more irrigation stations and may be one of many control unit 10 used to control an irrigation system that may span a large area. For example, a city or other municipal authority may operate an irrigation system associated with various public spaces spread throughout the city that includes several control systems 10. As noted above, a watering program may be provided to each control unit remotely via the radio R1 such that watering program updates can be provided to all control systems in the city at once. Ideally, the radio R1 would be active at all times to allow for constant updates to the watering program or entry of other instructions, for example, to stop watering in the event of rain. This, however, would quickly exhaust the power source, requiring replacement which is costly and inefficient. By activating the radio R1 based on the detection of flow through the valve V1, V2 controlled by the control unit 10, a window is provided to modify the program or to receive other instructions while allowing for power savings at all other times. As a result, operators are provided with the flexibility to change the watering program and/or to enter direct instructions to alter current or future operations, while maximizing power usage such that power source life is maximized. For example, in embodiments, when the valve V1 is opened and flow is detected by the flow sensor F1 (and/or F2), the radio R1 is activated and may receive an updated watering program, which may result in closing of the valve V1 or a change in the amount of time it is open, for example, or may include a specific instruction that may not change the program but may change current operation, for example, closing valve V1 now. This would be convenient, for example, in the case where the current watering program is desired, however, watering at this time is undesired, for example, because it is raining or will rain soon. Thus, the control system 10 allows for flexibility while maximizing power savings.

In embodiments, the flow sensor F1 may be provided downstream of the valve V1 in the line L1, as indicated in broken lines in FIG. 1. In embodiments, the flow sensor F1 may be integrated into the valve V1. In embodiments, more than one flow sensor F1 may be provided in fluid communication with line L1, for example, both upstream and downstream from the valve V1.

In embodiments, the control system 10 may control more than one valve. In embodiments, for example, a second valve V2 may be provided in fluid communication with line 2 and control flow of water in the line L2. In embodiments, a second flow sensor F2 may be provided upstream of the second valve V2 to detect flow of water through the valve V2 in the line L2. In embodiments, the second flow sensor F2 may be provided downstream of the valve V2 as indicated in broken lines. In embodiments, the second flow sensor F2 may be integrated into valve V2. In embodiments, the control unit 10 may activate the first radio R1 based on the detection flow through the valve V2. In embodiments, the radio R1 may be activated for a period of time when flow is detected and may return to a latent or deactivated state thereafter, as generally described above with respect to the flow sensor F1. In embodiments, the control unit 10 may activate the first radio R1 based on flow detected by any of the flow sensors F1 or F2.

In embodiments, the flow sensors F1, F2 may be positioned in the flow path of the valves V1 and V2, in lines L1, L2, respectively. In embodiments, the flow sensors F1, F2 may be turbine flow sensors that use a spinning turbine or wheel to detect the flow of water. In embodiments, where the flow sensors F1, F2 are turbine flow sensors, the spinning of the turbine or wheel may be used to generate electricity that may be used to recharge the power source 12, which may be a rechargeable battery, for example. In embodiments, the flow sensors F1, F2 may be implemented as mechanical switches that are pushed closed (or open) when water pressure in the first or second irrigation line pushed on them as the water flows. In embodiments, any suitable flow sensor may be used.

In embodiments, the control unit 10 may activate the second radio R2 based on the flow of water through the valves V1 and/or V2. In embodiments, by activating and deactivating the radios R1, R2 based on the flow of water, the radios need not be active all the time which conserves power and extends the life of the power source 12 while at the same time providing sufficient communication time to provide and update the watering program and monitoring the status of the control unit 10. Further, the use of the flow sensors F1, F2 to generate power allows for charging of the battery 12 and further extends the life of the power source. In embodiments, the radio R1 may be activated based on an instruction provided via the radio R2 such that a user nearby can connect to the control unit 10 via the radio R2 to activate radio R1 on demand, to allow for an update to the watering program or to receive any other instructions via radio R1. As noted above, in embodiments, updated watering programs or other instructions may be provided via radio R2 as well. In embodiments, the radio R2 may not be controlled based on flow detected by the sensors F1, F2. In embodiments, the radio R1 or R2 may be activated by the control unit 10 based on the watering program. In embodiments, the radio R1 may be activated just prior to or at the time that the valve V1 is scheduled to be opened in accordance with the watering program. In embodiments, the radio R1 may be activated just prior to or at the time that the valve V2 is scheduled to be opened in accordance with the watering program. In embodiments, the radio R1 may be activated just prior to or at the time that the valve V1 and/or the V2 is scheduled to be opened in accordance with the watering program. In embodiments, the radio R2 may be activated just prior to or at the time that the valve V1 is scheduled to be opened in accordance with the watering program. In embodiments, the radio R2 may be activated just prior to or at the time that the valve V2 is scheduled to be opened in accordance with the watering program. In embodiments, the radio R2 may be activated just prior to or at the time that the valve V1 and/or the V2 is scheduled to be opened in accordance with the watering program. In embodiments, the radios R1 and/or R2 may be activated just prior to or at the time that the valve V1 is scheduled to be opened in accordance with the watering program. In embodiments, the radios R1 and/or R2 may be activated just prior to or at the time that the valve V2 is scheduled to be opened in accordance with the watering program. In embodiments, the radios R1 and/or R2 may be activated just prior to or at the time that the valve V1 and/or the V2 is scheduled to be opened in accordance with the watering program. Providing for activation of the radios R1 and/or R2 just prior to scheduled activation times allows for updates of the watering program before it is implemented.

In embodiments, the control unit 10 may include processor 10a operably connected to memory 10b that includes processor executable code, that when executed by the processor determines a flow rate in the first irrigation line L1 and/or the second irrigation line L2, compares the flow rate to a first threshold and a second threshold different that the first threshold and generates a flow rate message when the flow rate exceeds the first threshold or drops below the second threshold and transmits the flow rate message using the radio R1 or R2 after it is activated. In embodiments, the first threshold may be associated with a maximum flow rate and the second threshold may be associated with a minimum flow rate. In embodiments, the first threshold and the second threshold may be included in the watering program provided in the memory or provided based on the watering program. In embodiments, the memory 10b may include processor executable code, that when executed by the processor generates a flow signal based on the flow information that indicates that flow has been detected and transmits the flow signal using the radio R1 or R2 after it is activated.

In embodiments, the watering program or instructions provided in memory 10b may include processor executable instructions that when executed by the processor 10a provide control signals to the first valve V1 and/or the second valve V2 to control flow of water in the first irrigation line L1 and/or the second irrigation line L2. In embodiments, the watering program may indicate or be associated with on times to open the valves V1, V2 as appropriate. In embodiments, where there is damage or a malfunction of the first valve V1, or the second valve V2, water may be flowing in the first irrigation line L1, or second irrigation line L2, beyond the on time, when the valve V1 or valve V2 is supposed to be closed. In embodiments, the memory 10b may include processor executable instructions that when executed, determine a flow time associated with a time when flow is detected based on the first flow information or second flow information, determine whether the flow time corresponds to an on time in the watering program and generate an alert signal when the flow time does not correspond to an on time such that flow should not be detected. The alert signal may be transmitted by the radio R1 or R2 after it is activated.

In embodiments, the memory 10b may include processor executable instructions that when executed, determine the on times based on the watering program and determine whether water is flowing during the on times based on the flow time discussed above. The processor 10a may generate an alert signal when there is no flow during one or more on time, which may indicate a problem with the valve V1 or V2, a problem in the first irrigation line L1 or the second irrigation line L2 or some other malfunction. In embodiments, the alert signal may be transmitted via the radio R1 or R2 after it is activated.

In embodiments, tracking flow of water through the valves V1, V2 also provides leak detection. In embodiments, for example, when flow of water is detected through one of the valves V1, V2 during a time that the valve is supposed to be closed in accordance with the watering program may indicate a leak or other malfunction in the valve(s) or the line(s) L1. L2. In embodiments, flow information as detected by the sensors F1, F2 may be communicated to an operator via the radio R1 and/or radio R2 and the operator may determine the presence of a leak based on the information. Alternatively, as noted above, where there is flow beyond the on time, the control unit 10 may provide an alert sent to the operator. For example, as is explained above the flow information may be processed at the control unit 10 and an alert may be generated in the event a leak or malfunction is identified based on the flow information and sent to the operator or others via the radio R1 or R2.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A control system comprises:
a control unit:
a first valve operably connected to the control unit and in fluid communication with a first irrigation line to control flow through the first irrigation line;
a first flow sensor provided in fluid communication with the first irrigation line, the first flow sensor operable to provide flow information associated with flow if water through the first irrigation line;
a first radio operably connected to the control unit and switchable from an active state in which the radio sends and receives information and a latent state in which it does not transmit or receive; and
a power source electrically connected to the control unit and first radio and to provide power thereto,
wherein the control unit activates the first radio after receiving flow information indicating flow of water in the first irrigation line.

2. The control system of claim 1, wherein the control unit comprises:
a processor; and
memory operably connected to the processor including processor executable code that when executed by the processor performs steps of:
receiving the flow information;
generating a first activation signal to activate the first radio when the flow information is received indicating flow of water in the first irrigation line; and
providing the first activation signal to the first radio to activate the first radio.

3. The control system of claim 2, wherein the first activation signal activates the first radio for a predetermine period of time.

4. The control system of claim 2, wherein the memory includes processor executable instructions that when executed by the processor performs steps of:
generating a deactivation signal a predetermined period of time after the activation signal is generated; and
sending the deactivation signal to the first radio.

5. The control system of claim 2, wherein the memory includes processor executable instructions that when executed by the processor performs steps of:
generating a deactivation signal after the flow information indicates that water is not flowing through the first irrigation line;
sending the deactivation signal to the first radio.

6. The control system of claim 1, wherein the first radio is configured to send and receive information using at least one of LTE, Cat-M, LTE-M, Cat NB-IoT, LTE Cat1, LoRaWAN, and Zigbee communication.

7. The control system of claim 1, wherein the first radio operates at a sub-Gigahertz frequency.

8. The control system of claim 1 further comprising:
a second valve operably connected to the control unit and in fluid communication with a second irrigation line to control flow through the second irrigation line; and
a second flow sensor provided in fluid communication with the second irrigation line, the second flow sensor operable to provide second flow information associated with flow of water through the second irrigation line,
wherein the control unit activates the first radio after receiving second flow information indicating flow of water in the second irrigation line.

9. The control system of claim 8, wherein the control unit activates the first radio after receiving the first flow information or the second flow information.

10. The control system of claim 1, further comprising a second radio operably connected to the control unit, wherein the control unit activates the second radio after receiving the first flow information indicating flow of water in the first irrigation line.

11. The control system of claim 10, wherein the second radio provides short range wireless communication.

12. The control system of claim 1, wherein the first flow sensor is a turbine flow sensor and configured to provide power to the power source when water is flowing through the first irrigation line.

13. The control system of claim 8, wherein the second flow sensor is a turbine flow sensor configured to provide power to the power source when water is flowing through the second irrigation line.

14. The control system of claim 2, wherein the memory includes processor executable instructions that when processed by the control system perform steps of processing the first flow information and determining whether water is leaking from the first irrigation line.

15. The control system of claim 14, wherein the step of processing the first flow information includes comparing the first flow information to a state of the first valve, wherein when the first flow information indicates water flow in the first irrigation line when the first valve is closed, a leak is indicated.

16. The control system of claim 8, wherein the memory includes processor executable instructions that when processed by the control system perform steps of:
processing the second flow information and determining whether water is leaking from the second irrigation line.

17. The control system of claim 16, wherein the step of processing the second flow information includes comparing the second flow information to a state of the second valve, wherein when the second flow information indicates water flow in the second irrigation line when the second valve is closed, a leak is indicated.

18. The control system of claim 2, wherein the processor executable instructions include watering program instructions that when executed by the processor perform steps of:
generating a first valve activation signal to activate the first valve to supply water to the first irrigation line.

19. The control system of claim 8, wherein the processor executable instructions include watering program instructions that when executed by the processor perform steps of:
generating a second valve activation signal to activate the second valve to supply water to the second irrigation line.

20. The control system of claim 2, wherein the memory includes processor executable code that, when executed by the processor, performs steps of:
calculating a flow rate based on the flow information;
generating a flow rate message when the flow rate exceeds a first threshold or falls below a second threshold; and
transmitting the flow rate message using the first radio.

21. The control system of claim 2, wherein the memory includes processor executable code that when executed by the processor performs steps of:
generating a flow signal indicating that flow has been detected based on the flow information; and
transmitting the flow signal using the first radio after the first radio is activated.

22. A control system comprises:
a control unit including:
a processor; and
memory operably connected to the processor including processor executable code including a watering program that when executed by the processor provides control signals;
a first valve operably connected to the control unit and in fluid communication with a first irrigation line to control flow through the first irrigation line based on the control signals;
a first radio operably connected to the control unit and switchable from an active state in which the radio sends and receives information and a latent state in which it does not transmit or receive; and
a power source electrically connected to the control unit and first radio and to provide power thereto,
wherein the control unit activates the first radio in accordance with the watering program.

23. A control system comprises:
a control unit including:
a processor; and
memory operably connected to the processor including processor executable code including a watering program that when executed by the processor provides control signals;
a first valve operably connected to the control unit and in fluid communication with a first irrigation line to control flow through the first irrigation line based on the control signals;
a first radio operably connected to the control unit and switchable from an active state in which the radio sends and receives information and a latent state in which it does not transmit or receive; and
a power source electrically connected to the control unit and first radio and to provide power thereto,
wherein the processor executable code, when executed by the processor, performs steps of:
establishing a flow time based on the flow information;
comparing the flow time to the watering program to determine whether the flow time corresponds to an on time for the first valve in accordance with the watering program;
generating an alert message when the flow time does not correspond to an on time for the first valve in accordance with the watering program; and
transmitting the alert message using the first radio.

24. A control system comprises:
a control unit including:
a processor; and
memory operably connected to the processor including processor executable code including a watering program that when executed by the processor provides control signals;
a first valve operably connected to the control unit and in fluid communication with a first irrigation line to control flow through the first irrigation line based on the control signals;
a first radio operably connected to the control unit and switchable from an active state in which the radio sends and receives information and a latent state in which it does not transmit or receive; and
a power source electrically connected to the control unit and first radio and to provide power thereto,
wherein the processor executable code, when executed by the processor, performs steps of:
determining an on time for the first valve based on the watering program;
determining whether water is flowing in the first irrigation line during the on time;
generating an alert message when the flow information indicates that water is not flowing in the first irrigation line during the on time; and
transmitting the alert message using the first radio.
